(19) United States
(12) Patent Application Publication
(10) Pub. No.: US 2009/0007968 A1
(43) Pub. Date: Jan. 8, 2009

(54) Pipe network, with a hierarchical structure, for supplying water or gas and/or for removing industrial water, process for detecting a leak in such a pipe network and process for determining, with the aid of a computer, the operating life theoretically remaining for a renewable power source for at least one flowmeter in such a pipe network

(75) Inventors: Christian Knecht, Kembs (FR); Jean-Franco Tracogna, Ruelisheim (FR); Fabien Hantzer, Illzach (FR); Urs Endress, Arlesheim (CH)

Correspondence Address: BACON & THOMAS, PLLC, 625 SLATERS LANE, FOURTH FLOOR, ALEXANDRIA, VA, 22314-1176, US

(73) Assignee: Endress + Hauser, Huningue Cedex (FR)

(21) Appl. No.: 11/794,054

(22) PCT Filed: Dec. 19, 2005
(86) PCT No.: PCT/EP2005/056914

§ 371 Date: Apr. 25, 2008

(30) Foreign Application Priority Data
Dec. 23, 2004 (DE) 10 2004 063 471.8

(51) Int. Cl. F17D 5/02; F17D 5/06; G01N 25/56

(52) U.S. Cl. 137/15.11; 137/557; 374/54

(57) ABSTRACT

Summary: The invention concerns a pipe network (10), with a hierarchical structure, for supplying water or gas and/or removing industrial water where the flowmeters (54-82) provided in the individual pipes are standalone units that are connected to a master flowmeter (52) in a master-slave network. The flowmeters (54-82) have their own, autarkic power supply system. By totaling the measured flow values in the lower-order pipes in the hierarchy and comparing the result with a measured flow value in the related pipe on the next highest level, a leak can be detected in one of the lower-order pipes.

In addition, the invention also concerns a process for detecting a leak in such a pipe network (10) and a process for determining—with the aid of a computer—the operating life theoretically remaining for a renewable power source for at least one flowmeter in such a pipe network.

The invention concerns a pipe network, with a hierarchical structure, for supplying water or gas and/or for removing industrial water, a process for detecting a leak in such a pipe network and a process for determining, with the aid of a computer, the operating life theoretically remaining for a renewable power source for at least one flowmeter in such a pipe network.

Such pipe networks are used to supply communities or other large settlements with water or gas and for disposing of industrial water. These pipe networks are usually installed underground such that it is very difficult to detect a leak in a pipe in the pipe network. It is well known that water and gas companies operating such pipe networks, for example, incur a loss as a result of such leakages as it is difficult to detect the leaks within an adequate time frame, particularly if the pipe networks extend across large areas, hardly any measuring instruments are installed in the pipe network and they are only marginally reliable or their function cannot be determined reliably.

The invention is thus based on the task of facilitating the reliable detection of leaks in a hierarchical pipe network used to supply water or gas and/or remove industrial water, where the reliable and permanent functioning of the measuring instruments deployed can be ensured.

This task is solved by a pipe network for supplying water or gas and/or removing industrial water, as per the invention, where the pipe network exhibits a hierarchical structure made up of pipe branches, and several pipe branches are fitted with at least one flowmeter. The flowmeters are standalone units, are connected to a master-slave network and communicate with one another using wireless technology.

An initial embodiment of the pipe network as per the invention provides for at least one flowmeter in a higher-order pipe branch to act as the master flowmeter and several other flowmeters in a lower-order pipe branch acting as slave flowmeters.

In another embodiment of the pipe network as per the invention, the slave flowmeter reports a measured value it determines to the master flowmeter.

In a further embodiment of the pipe network as per the invention, the slave flowmeters report the measured values they determine in their own particular pipe branch to the master flowmeter.

Yet another embodiment of the pipe network as per the invention provides for the fact that the slave flowmeters record a flow direction prevailing in their own particular pipe branch to the master flowmeter.

In yet another embodiment of the pipe network as per the invention, the master flowmeter calculates the sum of the individual measured values transmitted to it by the slave flowmeters.

In yet another embodiment of the pipe network as per the invention, the master flowmeter also communicates with a central station.

In another embodiment of the pipe network as per the invention, the master flowmeter sends an error or alarm signal, indicating a leak, to the central station if the total of the individual measured values from the slave flowmeters deviates—beyond a specific tolerance—from a value measured by the master flowmeter itself.

Additional embodiments of the pipe network as per the invention concern power supply to the flowmeters.

Other embodiments of the pipe network as per the invention focus on determining the remaining operating life of the power source for the flowmeters and communicating this information to the central station.

Further embodiments of the pipe network as per the invention refer to the types of power source used or the types or sensor units of the flowmeters and their possible calibration at the installation point.

Further embodiments of the pipe network as per the invention concern the hierarchical structure of the individual branches of the pipe network and how these can be bridged using a bypass.

The task mentioned above is also solved by a process, as per the invention, for detecting a leak in a pipe network for supplying water and/or removing industrial water, where the pipe network exhibits a hierarchical structure made up of pipe branches, and several pipe branches are fitted with at least one flowmeter, and where the flowmeters are standalone units, are connected to a master-slave network and communicate with one another using wireless technology
where the slave flowmeters in lower-order pipe branches report measured values they record to the master flowmeter which is arranged in a higher-order pipe branch;
where the master flowmeter calculates a total from the measured values of the slave flowmeters of the hierarchical levels in question and compares this total to a value measured for the next highest hierarchical level;
and where, if the total of the lower-order hierarchical level deviates from the value measured in the next highest hierarchical level and is outside a prespecified tolerance, an alarm signal is generated by the master flowmeter which indicates that the values do not tally and requests the pipe branch or branches be inspected.

A particular embodiment of this process as per the invention states that to inspect a single lower-order pipe branch for a possible leak, at least two ultrasonic flowmeters are used in the pipe branch affected, including lower-order pipe branches, where the time-of-flight values of the sonic signals from one ultrasonic flowmeter to another are determined and examined with regard to the sonic velocities which deviate from sonic velocities for the pipe branch, which were known or determined beforehand, taking into account a known distance between the ultrasonic flowmeters.

In another embodiment of the process mentioned above as per the invention, before actually emitting the alarm signal, the master flowmeter gets the system to check the function of the slave flowmeters in the pipe branches in question by causing the flowmeters to initialize control measurements and test sequences.

In yet another embodiment of the process mentioned above as per the invention, the pipe branch in question is individually examined for leaks by comparing the measured values that caused the alarm signal to be triggered against a reference curve created for the same pipe branch from earlier measurements.

In yet another embodiment of the process mentioned above as per the invention, the master flowmeter gets the system to check the function of the slave flowmeters at predefined times or predefined intervals by causing the flowmeters in question to initialize function control measurements and test sequences.

The task mentioned above is also solved using a process for determining—with the aid of a computer—the operating life theoretically remaining for a renewable power source for at least one flowmeter in a pipe network, as per the invention, with the following process steps:
Determine a matrix of influencing factors which affect the theoretical operating life of the power source;
Determine a theoretical operating life with a variation of different influencing factors or a combination thereof;
Record all the influencing factors from the point when the power source is installed to when it fails or terminates;
Record at least the influencing factors at specified times as a function of an operating time, which has elapsed by then, of the flowmeter in question;
Determine the operating life theoretically remaining with the aid of a matrix taking into account all the influencing factors recorded to date and the operating time that has elapsed;
Where all the process steps previously mentioned are performed on a computer connected to the flowmeter or flowmeters.

In a special embodiment of this process, the operating life theoretically remaining for the power source is determined each time the measuring cycle of the flowmeter is changed or periodically if the value has not been determined in the meantime as the measuring cycles had not changed.

Another embodiment of the process described as per the invention provides for the following process steps to determine the operating life theoretically remaining:
The computer determines various operating lives theoretically remaining for various value pairs of influencing factors;
The various operating lives theoretically remaining are displayed to the user on a display unit together with the various influencing factor value pairs, whereby the user is allowed change the values of the value pairs or the influencing factors on a data input unit of the computer;
When the user enters or changes the value pairs of influencing factors, the computer calculates a new operating life theoretically remaining based on the modified values and displays this on the computer display unit.

A further embodiment of the process described as per the invention concerns using the influencing factors, which affect a required measuring cycle of the flowmeter or flowmeters, within the value pairs of influencing factors the user ultimately selects to configure the flowmeter(s).

In another embodiment of the process described as per the invention, the operating life theoretically remaining for a renewable power source of one particular flowmeter or several flowmeters is determined periodically, such that the operating life theoretically remaining for the flowmeter(s) with the existing configuration is shown to the user who then has the option of changing the configuration and the new operating life theoretically remaining, as a result of the modified configuration, is then indicated.

Further embodiments of the process described as per the invention concern determining the current theoretical operating life of the power source in situations where a battery, or a unit comprising multiple batteries, acts as the power source for the flowmeter(s).

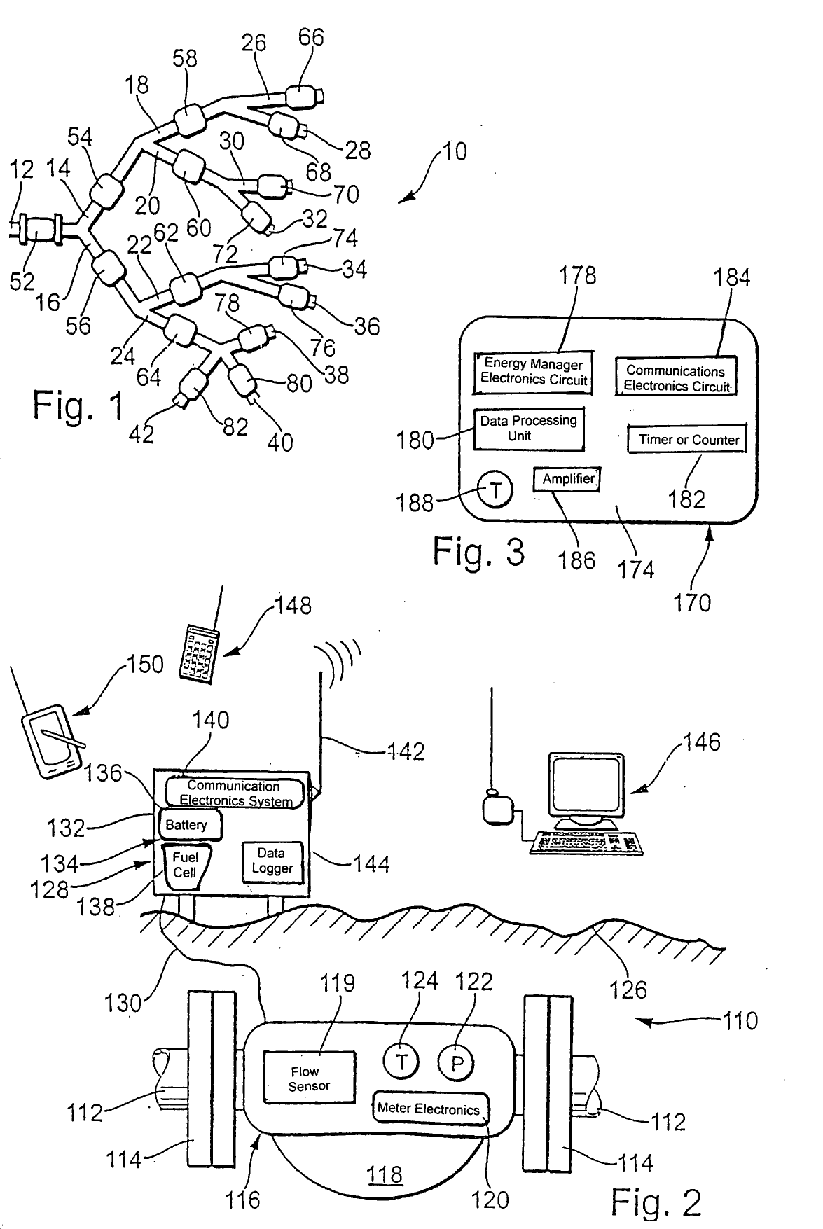

The invention is illustrated in the enclosed drawings, comprising FIG. 1 to FIG. 8.

The invention is described in greater detailed in the following section with reference made to the embodiments of the invention illustrated in the drawings.

FIG. 1 illustrates a schematic diagram of a pipe network for supplying water, as per the invention

FIG. 2 illustrates a schematic diagram of an initial embodiment of a flowmeter as per the invention with a communication unit FIG. 3 illustrates a schematic diagram of an electronics system of a further embodiment of a flowmeter as per the invention

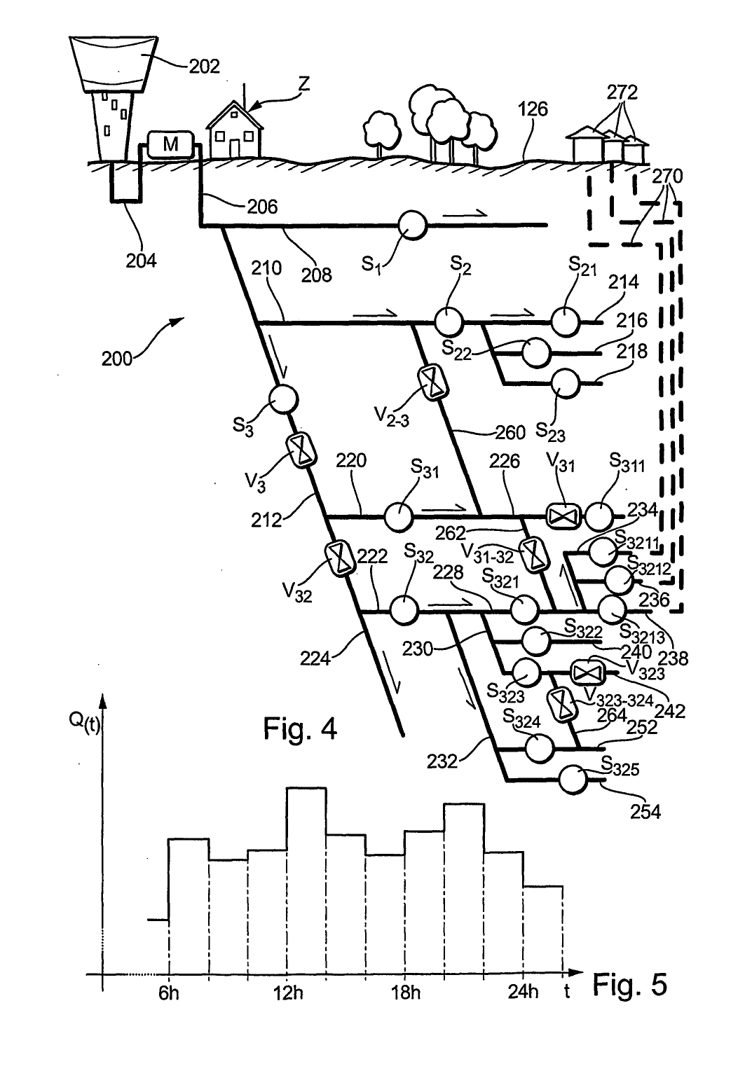

FIG. 4 illustrates a schematic diagram of part of a particular version of a pipe network for supplying water as per the invention

FIG. 5 illustrates an initial diagram on water consumption in the pipe network

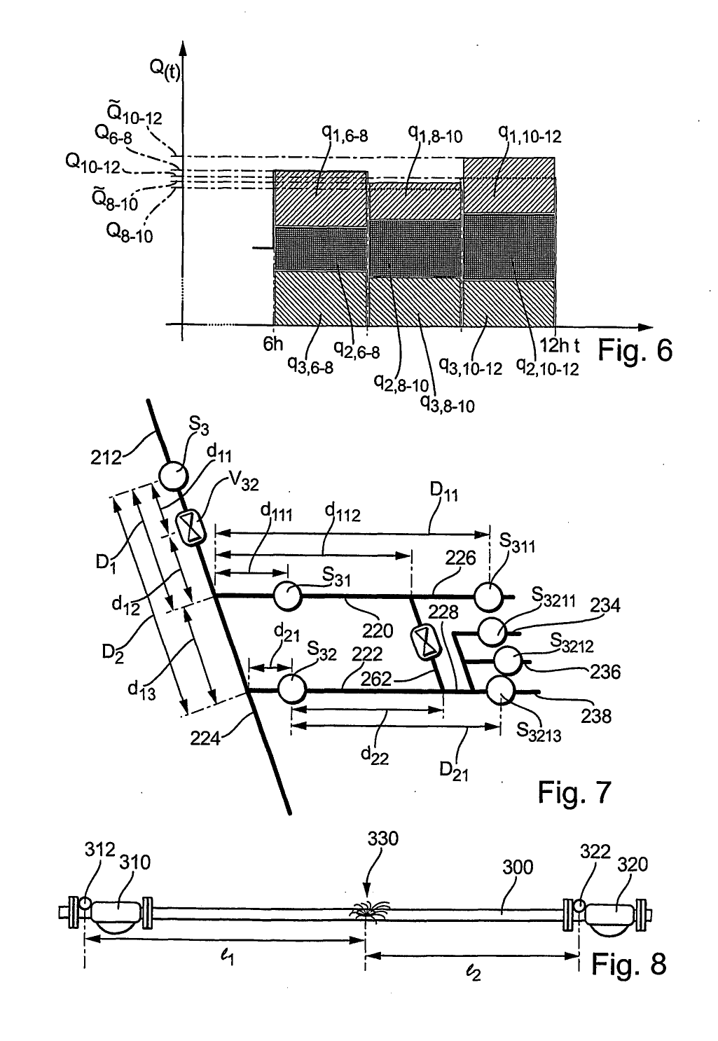

FIG. 6 illustrates a second diagram on water consumption in the pipe network

FIG. 7 illustrates a schematic diagram of a section of the pipe network as per FIG. 4

FIG. 8 illustrates a schematic diagram of a pipe run with a leak in the pipe network and a unit for detecting the leak

For the sake of simplicity, the same elements, components, modules or assemblies are given the same reference number in the drawings provided any confusion is ruled out.

FIG. 1 schematically illustrates a pipe network as per the invention.

This pipe network (10) is used to supply water to industrial operations and/or houses/households. As will be explained in greater detail below, this invention is suitable for pipe networks that are used to supply water or gas or to remove industrial water. In this respect, the term “pipe network” refers to all the uses mentioned above if a specific distinction is not made between water supply and gas supply systems or water disposal systems. These types of pipe networks are usually laid underground.

Such a pipe network does not only comprise a single pipe or pipeline. Instead it consists of several pipes and exhibits a hierarchical structure. Pipes branch off from a pipe on one level to form pipe branches. These pipes are then on the next lowest level. The majority of pipes are fitted with a flowmeter. In the pipe network (10) as per the invention illustrated in this sample embodiment, this is clear from a few pipes on various sublevels. FIG. 1 is used to illustrate the basic structure of a pipe network. In order to avoid confusion and ensure the diagram is transparent, only a section of the pipe network is schematically illustrated. In practice, pipe networks that are used to supply water or gas, or to remove industrial water, can extend over very large areas. Individual pipes can be several kilometers in length.

As illustrated in FIG. 1, lower-order, downstream pipes branch off from a higher-order pipe, which is regarded as the main pipe (12) here. The flow direction is from the main pipe to the lower-order pipes. The main pipe (12) splits into an initial pipe (14) on the first sublevel, and a second pipe (16) also on the first sublevel. In turn, an initial pipe (18) on the second sublevel and a second pipe (20) on the second sublevel branch off from the initial pipe (14) on the first sublevel. The second pipe (16) on the first sublevel splits into a third pipe (22) on the second sublevel and a fourth pipe (24) on the second sublevel.

The first pipe (18) on the second sublevel splits into an initial pipe (26) on the third sublevel, and a second pipe (28) on the third sublevel. The second pipe (20) on the second sublevel in turn splits into a third pipe (30) on the third sublevel, and a fourth pipe (32) on the third sublevel. The third pipe (22) on the second sublevel splits into a fifth pipe (34) on the third sublevel and a sixth pipe (36) on the third sublevel while the fourth pipe (24) on the second sublevel splits into a seventh pipe (38) on the third sublevel, an eighth pipe (40) on the third sublevel and a ninth pipe (42) on a third sublevel.

A flowmeter (52) is provided in the main pipe (12) to monitor the flow in the pipe network (10). A flowmeter (54) is provided in the first pipe (14) on the first sublevel and another flowmeter (56) is provided in the second pipe (16) on the first sublevel. Similarly, a flowmeter (58) is arranged in the first pipe (18) on the second sublevel and a flowmeter (60) is arranged in the second pipe (20) on the second sublevel. A flowmeter (62) is arranged in the third pipe (22) on the second sublevel and a flowmeter (64) is arranged in the fourth pipe (24) on the second sublevel. Furthermore, a flowmeter (66) is arranged in the first pipe (26) on the third sublevel, a flowmeter (68) is arranged in the second pipe (28) on the third sublevel, a flowmeter (70) is arranged in the third pipe (30) on the third sublevel, a flowmeter (72) is arranged in the fourth pipe (32) on the third sublevel, a flowmeter (74) is arranged in the fifth pipe (34) on the third sublevel, a flowmeter (76) is arranged in the sixth pipe (36) on the third sublevel, a flowmeter (78) is arranged in the seventh pipe (38) on the third sublevel, a flowmeter (80) is arranged in the eighth pipe (40) on the third sublevel and a flowmeter (82) is arranged in the ninth pipe (42) on the third sublevel.

The flowmeters (54-82) are standalone units with their own autarkic energy supply. The flowmeter (52) in the main pipe (12) can also be a standalone unit but this is not absolutely essential for the invention. As explained later, all the flowmeters (52-82) are able to communicate with one another using wireless technology, preferably deploying a bidirectional system, and are connected to a master-slave network. In this hierarchical master-slave network, the flowmeter (52) acts as the master flowmeter in a higher-order pipe and the other flowmeters (54-82) in lower-order or downstream pipe branches act as slave flowmeters. This means that the slave flowmeters (54-82) report a flow measured value which they determine in their own pipe to the master flowmeter (52). Preferably, the slave flowmeters (54-82) are fitted with a sensor which makes it possible to determine the prevailing flow direction in a pipe in addition to the flow. Together with the flow measured value and a corresponding unit ID, each slave flowmeter (54-82) communicates this flow direction wirelessly to the master flowmeter (52).

Practically, however, the technical design of several flowmeters in the pipes on the first and second level allow these flowmeters to take over the role of the master flowmeter and act as the master if the master fails.

The sum of the individual flow measured values transmitted by the slave flowmeters (54-82) of a lower-order pipe branch is calculated in the master flowmeter (52) and compared against a flow measured value of a flowmeter in the higher-order pipe branch in question. With regard to the pipe network (10) illustrated in FIG. 1, for example, the following relations exist presuming that the master flowmeter (52) is intact and the pipe network (10) does not have a leak or is not losing medium:
The sum of the flow measured values measured by flowmeters (66) and (68) corresponds to the flow measured value measured by flowmeter (58).
The sum of the flow measured values measured by flowmeters (70) and (72) corresponds to the flow measured value measured by flowmeter (60).
The sum of the flow measured values measured by flowmeters (74) and (76) corresponds to the flow measured value measured by flowmeter (62).
The sum of the flow measured values measured by flowmeters (78), (80) and (82) corresponds to the flow measured value measured by flowmeter (64).
The sum of the flow measured values measured by flowmeters (58) and (60) corresponds to the flow measured value measured by flowmeter (54).
The sum of the flow measured values measured by flowmeters (62) and (64) corresponds to the flow measured value measured by flowmeter (56).
The sum of the flow measured values measured by flowmeters (54) and (56) corresponds to the flow measured value measured by flowmeter (52).

The relations and dependencies explained above have to be expanded accordingly for a pipe network larger than that illustrated in FIG. 1.

These relations make it possible to determine whether a loss is occurring in a pipe from the first sublevel as the flow measurements in a lower-order pipe are always monitored by comparing the values against the flow measurement in the pipe on the next immediate upper level. For example, if the medium is flowing from the main pipe (12) to the lower-order pipes and there is a leak before the flowmeter (76) in the sixth pipe (36) on the third sublevel, the sum of the flow measured values measured in the flowmeters (74) and (76) no longer matches the flow measured value measured in the flowmeter (62) in the third pipe (22) on the second sublevel. The flow measured value measured in the flowmeter (62) is larger than the sum of the flow measured values that are measured in the flowmeters (74) and (76) since the leak causes the flowmeter (76) to measure too low a flow. A similar situation applies for leaks or other losses for the other measured values in other pipes.

The master flowmeter (52) is normally responsible for calculating the sum of the flow measured values in the lower-order pipes and comparing the value against the flow measured value of the related pipe on the next highest level. In pipe networks supplying water for industry and/or households, the flowmeter (52) in the main pipe (12) reports the flow measured values it measures to a measuring control room which can be a central station or another separate accounting center. When a leak is suspected in the pipe network observed, the master flowmeter (52) generates an alarm signal and reports this to the measuring control room or the accounting center. In the event of an alarm, the measuring control room can send out a team or an individual to locate the leak in the pipe network and seal it or repair it. As explained earlier, these types of pipe network are often very extensive. Even though a leak can be detected in a pipe branch in a pipe network as per the invention, in another embodiment of the invention it is possible to find the exact location of the leak by making additional measurements. This will be explained in greater detail later.

To invoice the flow values determined by the slave flowmeters, it is recommended to have at least one flowmeter as an instrument that is suitable for custody transfer measurement. Preferably, however, several flowmeters suitable for custody transfer measurement should be installed at points where there is important pipe branching in the pipe network (10). In the pipe network (10) illustrated in FIG. 1, for example, the master flowmeter (52) and the slave flowmeters (66-80) are flowmeters suitable for custody transfer measurement which can preferably be calibrated directly at their point of installation.

Pipe networks of this kind are usually managed by large operating and/or water utility companies or water disposal firms that charge for their service, the volume of water supplied or removed/disposed of and the provision of the pipe system. In this context, to record the volume of water supplied or disposed of for invoicing purposes, a central station is provided as an accounting center and the individual master flowmeters send the flow measured values they determine to this station.

FIG. 2 schematically illustrates a particular embodiment of a flowmeter as per the invention as it is used as a slave flowmeter (54-82) for example (see FIG. 1). This type of flowmeter (110) is installed in a pipe (112) of the pipe network (10), as per the invention (see FIG. 1), using two flanges (114). A measuring tube (118) with at least one flow sensor (119) is accommodated in a housing (116) of the flowmeter (110) (see also FIG. 1). Meter electronics (120) generate and receive measuring signals, analyze them with regard to the desired measured value and forward the flow measured values to a master flowmeter for transmission.

Preferably, a pressure sensor (122) and a temperature sensor (124) are also accommodated in the housing (116). The pressure present in the pipe (112) observed here can be recorded with the pressure sensor (122). The temperature sensor (124) is used to record a temperature in the pipe (112) or the housing (116) of the flowmeter (110). Pipes (112) of this kind are usually routed underground. As explained, the flowmeter (110) is integrated in the pipe (112) and thus also arranged under the surface of the ground (126).

The flowmeter (110) is electrically connected to a communication and power supply unit (128) by at least one cable (130). In the version illustrated here, the communication and power supply unit (128) is located above the surface of the ground (126) and above or very close to the flowmeter (110). The housing (132) of the communication and power supply unit (128) accommodates an energy supply unit (134) which is used to supply power to the flowmeter (110) and the electrical/electronic units in the communication and power supply unit (128). The energy supply unit (134) preferably comprises one or more batteries (136). A fuel cell (138), which is illustrated in FIG. 2, can also be used instead of the battery or batteries (136). It is also conceivable to fit the housing (132) of the communication and power supply unit (128) with solar cells such that, with appropriate sunshine, power is supplied to the flowmeter (110) and the communication and power supply unit (128) and/or the battery/batteries (134) can be charged.

A communication electronics system (140) in the housing (132) of the communication and power supply unit (128), which is connected to an antenna (142), is used to communicate with communication and power supply units of other flowmeters. In this way, for example, the data measured by slave flowmeters (54-82) in the pipe network (10) (see also FIG. 1) are transmitted to the master flowmeter (52). Wireless communication using the antenna (142) also means that the flowmeter (110) in question can also communicate with other instruments enabled for wireless communication, such as a personal computer (PC) (146), a notebook where necessary, a handheld control unit (148)—as commonly used in industrial systems—and a personal digital assistant (PDA) (150). Thus, the communication and power supply unit (128) can receive data from other flowmeters, the PC, the PDA or the handheld control unit (148) or send data to these units. In this way, it is also possible to use one of the latter units to configure the flowmeter (110) via its communication and power supply unit (128) or to receive alarms from the flowmeter (110).

Preferably, the communication and power supply unit (128) also accommodates a data logger (144) as a kind of memory unit on which measured data and data pertaining to the status of the flowmeter (110) and/or the communication and power supply unit (128) can be stored. These type of data loggers (144)—particularly if they can be replaced or removed from the communication and power supply unit (128)—have the advantage that the stored data can be read out as required even if the communication and power supply unit (128) fails for some reason. As the pipe network (10) (see FIG. 1) can cover an extensive area, each slave flowmeter is preferably equipped with its own energy supply unit (128).

FIG. 3 illustrates a schematic diagram of an electronics system of a further embodiment for a flowmeter as per the invention. This electronics system, which comprises various modules illustrated in FIG. 3, is located in a communication and power supply unit (170), or—to be more precise—in a housing (174) of the communication and power supply unit (170). An energy manager electronic circuit (178) monitors—either constantly or at the request of a master flowmeter (52) (see FIG. 1)—the status of the energy supply unit (134), i.e. the status of the battery/batteries (136) or the fuel cell (138) with regard to the remaining operating life under current conditions such as measuring cycles, ambient temperature etc. If the housing (174) of the communication and power supply unit (170) is fitted with solar cells—as already explained above for the embodiment in FIG. 2, the energy manager electronic circuit (178) checks the power supply of the flowmeter(s) (110) (see FIG. 2) and a charging routine for rechargeable batteries (136). A data processing unit (180) is also provided in the embodiment illustrated in FIG. 3. This data processing unit (180) can assume the tasks of the evaluation unit (120) in the flowmeter (110) (see FIG. 2) and acts in its stead where necessary. Should a data logger also be provided for the communication and power supply unit (170) illustrated in FIG. 3, which corresponds to the data logger (144) as per FIG. 2 but is not illustrated in FIG. 3 for the purpose of simplicity, the data processing unit (180) checks what data are stored on the data logger, or what data are deleted if the memory unit overruns.

In addition to the data logger, the communication and power supply unit (170) also accommodates a timer (182) which is designed as a timer circuit and/or counter. This timer (182) is used to monitor the desired measuring cycle for the flow measurement and also the transmission of flow measured values if the values are to be transmitted with a time delay and not directly after measuring has taken place. In addition, the timer (182) can be used to send a general heartbeat signal for the flowmeter (110) (see FIG. 2) if the system is designed in such a way that such a heartbeat should be issued at certain times or after a certain number of measurements. A communications electronics system (184) provided with the communication and power supply unit (170) primarily corresponds to the communication electronics system (140) as per FIG. 2. In the example illustrated in FIG. 3, it is also connected to a sender and receiver antenna which is not illustrated in FIG. 3 for reasons of transparency. An amplifier (186) can also be used to amplify low signals. An energy supply unit (134) (see FIG. 2) is also provided in the communication and power supply unit (170) illustrated in FIG. 3. It has already been described in the section on FIG. 2. For the purposes of simplicity, however, it is not illustrated in FIG. 3.

A temperature sensor (188) provided in the communication and power supply unit (170) is used to detect impermissible heating and temperatures within the housing (174), the communication and power supply unit (170) and the electronic circuits they contain. Such impermissible heating and temperatures within the housing (174) can indicate that the electronic circuits are defect or point to altered ambient conditions that can have a negative impact on the operating life of the communication and power supply unit (170) and, particularly, the energy supply unit (134)—i.e. the battery (132) or fuel cell (138) it contains. If the system detects impermissible heating or temperature within the housing (174), a corresponding alarm signal is generated via the data processing unit (180) and communicated wirelessly to a master flowmeter or another measuring control room by means of the communication electronics system (184). From here, measures can be put in place to inspect the flowmeter in question and repair it where necessary.

Up to now, we have described the communication and power supply unit (128) and (170) for slave flowmeters illustrated in FIGS. 2 and 3. A corresponding electronics system can be used—and is preferably used—in a communication and power supply unit for a master flowmeter. In such instances, the data processing unit 180 (see FIG. 3) is responsible for calculating the sum of the individual flow measured values received from slave flowmeters for a pipe branch—as explained above—and comparing the value to the flow measured value which the slave flowmeter measured in the pipe on the next highest level and sent to the master flowmeter. The data processing unit (180) then generates alarm signals where necessary and transmits these to the measuring control room and/or accounting center responsible.

FIG. 4 schematically illustrates a part of another particular version of a pipe network, as per the invention, taking the example of a water supply system. This pipe network (200) also has a hierarchical structure like the pipe network illustrated in FIG. 1 and is made up of pipe branches on different levels. The pipe network (200) is not illustrated in full and should only be used for the purposes of visualizing and comprehending the system. Thus, the proportions of the pipes selected here do not necessarily match those of an actual pipe network whose pipes can extend over kilometers in practice.

A supply pipe (204) runs from a water reservoir (202)—for example a water tower—to a master flowmeter M whose other end is connected to a main pipe (206). An initial pipe (208) on the first sublevel, a second pipe (210) on the first sublevel and a third pipe (212) on the first sublevel branch off from this main pipe (206). Slave flowmeters S1, S2 and S3 are integrated in pipes (208), (210) and (212) respectively.

The second pipe (210) on the first sublevel splits into an initial pipe (214) on the second sublevel, a second pipe (216) on the second sublevel and a third pipe (218) on the second sublevel in which slave flowmeters S21, S22 and S23 are integrated respectively. The third pipe (212) on the first sublevel splits into a fourth pipe (220) on the second sublevel, a fifth pipe (222) on the second sublevel and a sixth pipe (224) on the second sublevel. A slave flowmeter (S31) is installed in the fourth pipe (220) on the second level and a slave flowmeter (S32) is installed in the fifth pipe (222) on the second sublevel.

The fourth pipe (220) on the second sublevel continues as an initial pipe (226) on the third sublevel where a slave flowmeter (S311) is fitted. The fifth pipe (222) on the second sublevel splits into a second pipe (228) on the third sublevel, a third pipe (230) on the third sublevel and a fourth pipe (232) on the third sublevel. A slave flowmeter (S321) is installed in the second pipe (228) on the third sublevel. The second pipe (228) on the third sublevel splits into an initial pipe (234) on the fourth sublevel, in which a slave flowmeter (S3211) is installed, a second pipe (236) on the fourth sublevel where a slave flowmeter (S3212) is installed and a third pipe (238) on the fourth sublevel with a slave flowmeter (S3213). The third pipe (230) on the third sublevel splits into a fourth pipe (240) on the fourth sublevel, in which a slave flowmeter (S322) is installed, and into a fifth pipe (242) on the fourth sublevel with a slave flowmeter (S323). The fourth pipe (232) on the third sublevel, in turn, splits into a sixth pipe (252) on the fourth sublevel where a slave flowmeter (S324) is installed and into a seventh pipe (254) on the fourth sublevel with a slave flowmeter (S325).

To ensure that water can be supplied or removed in the pipe network in question (200) even when leaks are present, bypass pipes and valves are provided to be able to seal off defect pipe branches and bypass them. In part of the sample pipe network (200) schematically illustrated in FIG. 4 an initial bypass pipe (260) is provided between the second pipe (210) on the first sublevel and the fourth pipe (220) on the second sublevel. This bypass pipe can be closed or opened where necessary using an integrated shutoff valve V2-3. A second bypass pipe (262) is located between the first pipe (226) on the third sublevel and the second pipe (228) on the third sublevel. This second bypass pipe (262) can also be sealed or opened as required by a shutoff valve V31-32 installed in the bypass. A third bypass pipe (264) is installed between the fifth pipe (242) on the fourth sublevel and the sixth pipe (252) on the fourth sublevel. This third bypass pipe (264) can be sealed or opened as required by a shutoff valve V323-324 in (264).

Shutoff valves are also provided in some pipes on different sublevels. Thus, shutoff valve V3 is accommodated in the third pipe (212) on the first sublevel, shutoff valve V31 is accommodated in the first pipe (226) on the third sublevel, shutoff valve V32 is accommodated in the sixth pipe (224) on the second sublevel and shutoff valve V323 is accommodated in the fifth pipe (242) on the fourth sublevel.

To complete the sample pipe network (200) illustrated in FIG. 4, domestic pipelines (270) are also illustrated via which water is supplied to the houses (272). For accounting purposes, the flow measured values determined by the master flowmeter M, which is installed between the supply pipe (204) and the main pipe (206) are sent to a central station Z which is normally an accounting center.

As already explained above for the pipe network (10) illustrated in FIG. 1, a leak can also be detected in the hierarchical pipe network (200) as per FIG. 4 by comparing the flow measured values measured in the individual pipes. If, for example, we first observe the pipe branch from the main pipe (206), the first pipe (208), the second pipe (210) and the third pipe (212) on the first sublevel, the total of the flow measured values returned by the slave flowmeters S1, S2 and S3 at a specific time should correspond to the flow measured value determined by the master flowmeter M, within definable limits, if there are no leaks in these pipes or in the downstream pipes. If medium is flowing through the pipes (208), (210) and (212) in the direction as indicated in FIG. 4 by the arrows and the master flowmeter M determines a flow measured value which is larger than the expected total value of the measurements from the slave flowmeters S1, S2 and S3, it can be assumed that at least one of the slave flowmeters S1, S2 and S3 could measure less flow as a result of loss in the pipe as there is a leak in a pipe before at least one of the slave flowmeters S1, S2 and S3.

A similar situation can be observed, for example, for the pipe branch from the second pipe (228) on the third sublevel with the slave flowmeter S321, the first pipe (234) on the fourth sublevel with the slave flowmeter S3211, the second pipe (236) on the fourth sublevel with the slave flowmeter S3212 and the third pipe (238) on the fourth sublevel with the slave flowmeter S3213. If medium is flowing through the pipes (228), (234), (236) and (238) in the direction as indicated in FIG. 4 by the arrows and the slave flowmeter S321 determines a flow measured value which is larger than the expected total value of the measurements from the slave flowmeters S3211, S3212 and S3213 at the same time, it can be assumed that at least one of the slave flowmeters S3211, S3212 and S3213 could measure less flow as a result of loss from a leak in the pipe.

For all other pipe branches of a pipe supply network where slave flowmeters are installed in a higher-order pipe and in the pipes on the next lower level immediately branching off from the higher-order pipe, similar conditions to those described above apply when a leak occurs. If, on the other hand, the pipe network is used to remove and dispose of water, where the medium transported in the pipes flows from the lowest-order pipes to the highest-order pipes, the flow in the opposite direction alters the conditions. In the event of a leak in a lower-order pipe after the slave flowmeter installed there—or before the pipe on the next highest level when viewed in the flow direction—the slave flowmeter in this higher-level pipe exhibits a flow measured value which is lower than the sum of the flow measured values measured by the slave flowmeters in the lower-order pipes.

The embodiments of the sample pipe network (200) described here and illustrated in FIG. 4 use the flowmeters (110)—previously described and illustrated in FIGS. 2 and 3—with their overground communication and power supply units (128) or (170). The master flowmeter M in the pipe network (200) also has facilities for wireless communication to communicate with the slave flowmeters in the lower-order pipes. However, it is preferably connected to a continuous power supply through a fixed grid so that the unit only has to use batteries—which may also be used in the related communication and power supply unit—in an emergency if the power supply from the grid fails.

As already explained above, for reasons of redundancy it makes sense that some slave flowmeters have the same functions as the master flowmeter. Normally, however, each of these special slave flowmeters remains a slave flowmeter until it has to replace the master unit. Under this premise, all the slave flowmeters communicate the flow measured values they measured at specific times to the master flowmeter. The totals of the flow measured values measured by the slave flowmeters in the individual pipes are then calculated in the master flowmeter—which is preferably fitted with a data processing unit (180) (see also FIG. 3)—whereby the totals of the lower-order pipes are compared against the flow measured value measured in the next highest pipe as explained above. If the values deviate from each other, thereby indicating a possible leak, an alarm is generated which is then communicated to the measuring control room or accounting center responsible. The accounting center will then take appropriate action to locate and rectify the leak in the pipe network (200). To ensure that the flow measurements were correct from the slave flowmeters which indicated the leak, before issuing the alarm the master flowmeter preferably triggers a function check to be run on the slave flowmeters in the pipe branches in question by causing the flowmeters to initialize control measurements or test sequences. An alarm is only sent to the measuring control room or accounting center once the flow measured values, and thus the possible leak, have been confirmed.

To increase the accuracy for finding a leak in the pipe branch observed, the system individually examines the flow measured values that were measured in the lower-order pipes and were taken into account when the master flowmeter M calculated the sum during the analysis process. In a usual pipe network (200) of the type illustrated, typical average consumption values of the medium which is supplied to/or removed from households or industrial operations via the pipe network can be determined and recorded. In the sample pipe network (200) illustrated, the flow measured values measured in the lower-order pipes are recorded for a specific timeframe by the flowmeters installed in these pipes and average, typical values are then calculated. An example of such a chart is illustrated in FIG. 5. This chart illustrates the flow measured values measured by a slave flowmeter over a specific time t—here from 6 a.m. to 2 a.m. the following day—in a typical water or gas supply network, as resulting from the typical water or gas consumption Q(t) of several households that are connected to the pipe network. At 6 a.m. on any weekday, the consumption of water or gas surges when the people living in the households get up, remains at practically the same level until midday to then surge again around 12 p.m. Then the measured flow or consumption of gas or water increases again until about 8 p.m. to then drop to a low nighttime level. Such a chart can be determined and recorded over an extended period for every one of the slave flowmeters in the pipe network observed.

If a leak is now suspected in one of the lower-order pipes where the sum of their actual measured flow values does not match the actual flow value measured in the pipe on the next highest level, the measured flow measured values of every lower-order pipe are compared to the typical flow charts recorded for every pipe.

If one of the flow values measured during this time now deviates greatly—i.e. beyond an agreed maximum tolerance—from the flow value specified in the related typical flow chart, this is most probably the pipe with the leak.

To make this clearer, FIG. 6 illustrates another example of a typical flow chart for a pipe branch. Here, the flow Q(t) is recorded over the time t, whereby the flow values for each set of two hours is averaged, similar to the chart in FIG. 5. In FIG. 6, a pipe branch is observed from a pipe on the xth sublevel and three lower-order pipes branching off from this pipe, i.e. (x+1)-th sublevel.

FIG. 6 illustrates how the flow value Q68 for the time from 6 a.m. to 8 a.m. in the pipe on the xth sublevel is made up of the three flow values q_{1,6-8} and q_{2,6-8} and q_{3,6-8} in the three downstream pipes on the (x+1)th sublevel. The flow value Q₈₋₁₀ for the time from 8 a.m. to 10 a.m. in the pipe on the xth sublevel is made up of the three flow values q_{1,8-10} and q_{2,8-10} and q_{3,8-10} in the three downstream pipes and the flow value Q₁₀₋₁₂ for the time from 10 a.m. to 12 midday in the pipe on the x-th sublevel from the three flow values q_{1,10-12} and

q_{2,10-12} and q_{3,10-12} in the three downstream pipes. In addition, it is clear from the chart in FIG. 6 that the flow values in the individual downstream pipes vary depending on the time of day. Their relation to one another changes depending on the time in question. The values Q^{˜}₆₋₈ and Q^{˜}₈₋₁₀ and Q^{˜}₁₀₋₁₂ are also entered in FIG. 6 which illustrate permissible fluctuations in the average flow values at the particular times of the day. These are then the flow values that are used for determining the leak as described above. A flow chart, like that illustrated in FIGS. 5 and 6, can be created for each individual pipe that is fitted with a flowmeter in the pipe network observed.

With the process we have just described, it is possible to detect a leak in a hierarchical pipe network for supplying water or gas by comparing a flow measured value measured in a pipe at a specific time against the total of the measured flow measured values in the pipes branching off from this pipe (pipes on the next lowest level). In this way, it is possible to identify the pipe branch which contains a leak in one of the downstream pipes. With the aid of the charts as illustrated in FIGS. 5 and 6 for the downstream pipes in question, it is also possible to identify the actual pipe where the leak is located. If the damaged pipe is a relatively short pipe, technicians will be able to quickly locate the exact location of the leak by inspecting the pipe visually. In such situations, the pipe can be sealed relatively quickly and the loss incurred from leaking water or gas are kept to a minimum.

If, however, the defect pipe is a long pipe extending over several kilometers for example, it would take a long time to inspect the entire pipe. In situations where flowmeters using ultrasonic signals are at least installed at critical pipe branches where there is a greater risk of leaks than in other parts of the pipe network, since the pipes are older or some other influencing factors are present, the invention provides for another step to be taken to locate the leak more accurately in very long pipelines. This is explained in greater detail using the section of the pipe network (200), as per FIG. 4, schematically illustrated in FIG. 7 in conjunction with the leak schematically illustrated in FIG. 8.

Ultrasonic flowmeters used in pipes to measure flow normally work with two transducers whose distance between one another defines a measurement section. Each transducer works as a sender and receiver such that ultrasonic signals that are sent from a transducer into a medium transported in the pipe are received by the other transducer. The signals are sent alternately in both directions and the time-of-flight of the signals is determined. Signals sent in the flow direction of the medium in the pipe return time-of-flight values that are different to signals opposed to the flow direction of the medium. With precise knowledge of the medium, the difference in the time-of-flight values is a way of determining the flow.

For flow measurement, the measurement section along the path of the medium is undisturbed as it is in the flowmeter.

Usually, only the signals across the measurement section—i.e. between the two transducers—are used to measure the flow. However, it is possible for a transducer in a flowmeter in a pipe to receive measuring signals from a transducer of an ultrasonic flowmeter in a lower-order or higher-order pipe which is connected to the first pipe. Here, the actual path of the medium in these pipes, which is not always undisturbed, plays a role

and can be used to accurately detect a leak in a very long pipe.

For example, in the section of the pipe network (200) as per FIG. 4 schematically illustrated in FIG. 7, a leak was found in the fourth pipe (220) on the second sublevel before the slave flowmeter S31 based on the process described above. It is presumed that the slave flowmeter S31 and the slave flowmeter S32 in the fifth pipe (222) on the second sublevel and the slave flowmeter S3 in the third pipe (212) on the first sublevel are preferably ultrasonic flowmeters and these flowmeters are equipped in such a way that they can receive signals from their own transducers and also receive signals from neighboring slave flowmeters.

If an ultrasonic signal is now sent from the slave flowmeter S31 in the direction of the slave flowmeter S3, this signal will arrive at slave flowmeter S3 after a certain time-of-flight and at the slave flowmeter S32 after another time-of-flight. The path covered by the ultrasonic signal from the slave flowmeter S31 to the slave flowmeter S3 is made up of the paths d111 and D1, as illustrated in FIG. 7. If the propagation velocity of the ultrasonic signals in the medium in the pipes is known, the time-of-flight of a signal actually determined by the slave flowmeters S3 and S31 can be compared to the time-of-flight which can be theoretically calculated but the flow direction of the medium must be taken into consideration here. If there is a leak in the pipe observed, the ultrasonic signals propagate at a different speed than in a pipe without any disturbances.

In addition, in the slave flowmeter S3 it is possible to measure a reflection signal from a junction of the fourth pipe (220) on the second sublevel with the third pipe (212) on the first sublevel. The signal originally emitted by the slave flowmeter S31 runs through the known section marked “d111” in FIG. 7, is reflected at the pipe branch-off section, runs back through d1 in the opposite direction and can be received at slave flowmeter S31. The time-of-flight measured here for this reflection signal can again be compared to the theoretical value taking the flow direction of the medium into account. A leak in the fourth pipe (220) on the second sublevel causes a disruption in the flow of the medium which either causes the propagation velocity of the signals to be reduced or the ultrasonic signal to be reflected. A leak between the slave flowmeter S31 and the pipe branch point can be detected by a reflection signal recorded in the slave flowmeter S31 which arrives at the slave flowmeter S31 before the reflection signal of the pipe branch point. The exact location of the leak can be determined by comparing the time-of-flight of a presumed reflection signal at the leak to the time-of-flight of the reflection signal from the pipe branch.

To be absolutely certain, the exact location of the leak in the fourth pipe (220) on the second sublevel before the slave flowmeter S31 can also be determined and thus checked using ultrasonic signals from the slave flowmeter S3. A signal sent by the slave flowmeter S3 in the direction of the fourth pipe (220) on the second sublevel causes an initial reflection at the shutoff valve V32 which is installed in the third pipe (212) on the first sublevel at a known distance d11 from the slave flowmeter S3. Another reflection signal arriving later on at the slave flowmeter S3 comes from the pipe branch in the fourth pipe (220) on the second sublevel. A further reflection signal coming from the slave flowmeter S31 can be determined some time later by the slave flowmeter S3. This latter reflection signal runs through sections d11, d12 and d111 illustrated in FIG. 7 in both directions (there and back). Within half the time, the slave flowmeter S31 should be able to determine the signal emitted by the slave flowmeter S3. If, however, the slave flowmeter S3 records a signal which arrives after the reflection signal from the pipe branch point but prior to the reflection signal which can be theoretically calculated at the slave flowmeter S31, this is most probably a reflection signal at a leak in the fourth pipe (220) on the second sublevel before the slave flowmeter S31. By comparing the time-of-flight of this leak reflection signal to the time-of-flight of the reflection signal for the pipe branch point, the exact distance of the leak from the pipe branch point can be determined if the path D1 from the slave flowmeter S3 to the pipe branch point is known. If no more medium reaches the slave flowmeter S31 as a result of the leak which would have been indicated here already by a flow which could not be determined, the slave flowmeter (3) would not be able to record a reflection signal from the slave flowmeter (31). The signal propagation velocity which has altered as a result of the leak also indicates that a leak is present.

Similarly, other slave flowmeters illustrated in FIG. 7, such as the slave flowmeter S32, can be used to locate a leak in the fourth pipe (220) on the second sublevel before the slave flowmeter S31. In the same way, leaks in the first pipe (234), the second pipe (236) or the third pipe (238) on the fourth sublevel before the slave flowmeters S3211, S3212 or S3213 installed there can be located accurately with the aid of signals that are sent from the slave flowmeters S32 to these pipes (234), (236), (238).

In the same way, it is possible to locate a leak in pipes other than those illustrated in FIG. 7.

The processes illustrated in FIG. 7 for pinpointing a leak in a pipe in a pipe network use ultrasonic flowmeters and the signals transmitted through the medium. For instances in which other types of flowmeters are already installed in the pipe network, leaks can be localized precisely by ultrasonic measuring instruments additionally installed in critical pipe branches. As illustrated in FIG. 8 taking the example of a random pipe (300), in addition to an initial flowmeter (310), which does not work with ultrasonic measuring signals, an initial ultrasonic measuring instrument (312) can be mounted on the pipe (300) near or directly at the first flowmeter (310). The ultrasonic measuring instrument (312) does not have to be an ultrasonic flowmeter. It just has to exhibit a transducer that can send and receive ultrasonic signals. The signals do not necessarily have to be sent into the pipe—i.e. into the medium transported here. Instead, signals can also be introduced into a wall of the pipe (300) like structure-borne signals or surface signals. If the ultrasonic measuring instrument (312) does not have its own power supply, mounting beside a flowmeter (310) allows the ultrasonic measuring instrument (312) to use the power source that supplies power to the flowmeter (310).

In the event of a second flowmeter (320) that does not work with ultrasonic measuring signals, another second ultrasonic measuring instrument (322) can be mounted on the pipe (300) near, or directly at, the second flowmeter (320). The information outlined in the previous paragraph for the first ultrasonic measuring instrument (312) also applies here. A leak (330) in the pipe (300), which is at a distance 1, away from the first ultrasonic measuring instrument (312) and a distance 12 away from the second ultrasonic measuring instrument (322), constitutes a point of disturbance for the propagation of signals in the pipe (300) which are sent from one of the ultrasonic measuring instruments (312) or (322) to the other ultrasonic measuring instrument (312) or (322). If the first ultrasonic measuring instrument (312) sends a signal to or into the pipe (300), a reflection signal occurs at the leak (330) which runs back along the path 11 to the first ultrasonic measuring instrument (312). This reflection signal will arrive at the first ultrasonic measuring instrument (312) before the reflection signal that occurs at the second ultrasonic measuring instrument (322) itself. When the propagation velocity of the signal into or onto a wall of the pipe (300) is known, the path 1, can be determined with relative accuracy as the distance of the leak from the first ultrasonic measuring instrument (312). Similarly, signals from the second ultrasonic measuring instrument (322) can be used to determine the path 12 as the distance of the leak (330) from the second ultrasonic measuring instrument (322). It also should be noted that the propagation velocity of the signals in the medium changes along the pipe observed due to the leak.

In addition to the option described above of installing the ultrasonic measuring instrument (312) and (322) on the pipe (300) and beside the flowmeters (310) or (320), it is also possible to accommodate the flowmeter (310) and the ultrasonic measuring instrument (312) in a single common housing. Flowmeter 320 and the ultrasonic measuring instrument (322) can be combined in one common housing.

In the embodiments described of the pipe networks (10), (200) as per the invention, it was presumed that each slave flowmeter is assigned its own energy supply unit (134) in the form of an independent and renewable power source, as explained in FIG. 2 and the related text on the diagram. As mentioned above, the energy supply unit (134) is preferably accommodated in the communication and power supply unit pertaining to each slave flowmeter. In contrast to most slave flowmeters, the communication and power supply unit is installed above ground. Installing on the surface of the ground makes it easier to replace the power source.

On the other hand, as already explained above, the pipe networks observed for supplying water or gas, or for removing used water, can be very extensive. To ensure that the slave flowmeters work all the time, the energy supply must be backed up or suitable measures should be taken that allow power sources that are almost depleted to be exchanged quickly. In the invention, this is achieved in that every slave flowmeter determines the remaining operating life of the power source assigned to it at specified times. If a predefined remaining power level is undershot, the slave flowmeter sends an appropriate signal to the master flowmeter via the slave's communication and power supply unit. The master flowmeter forwards this signal to a measuring control room or central station where measures can be taken to replace the power source.

Since great importance is applied to ensuring continuous energy supply to the slave flowmeters, it makes sense to set up the slave flowmeters in such a way that the master flowmeter periodically prompts the slave flowmeters to determine the remaining operating life of the power source themselves and forward this information to the master flowmeter. When the master flowmeter sends the information on the remaining operating life of the power sources to the central station or measuring control room, the continuous functioning of the slave flowmeters can be monitored centrally from there.

The operating life theoretically remaining for the renewable power source observed is determined by a slave flowmeter with the aid of a computer as follows. A matrix of influencing factors that affect the theoretical operating life of the power source (136) or (138) is saved in the slave flowmeter, preferably the communication and power supply unit (170) (see FIG. 3), together with various theoretical operating lives for different variations or patterns of various influencing factors or combinations thereof. From the point when the power source (136) or (138) is installed, the influencing factors are monitored at the site of the related slave flowmeter until the power source fails or terminates. Preferably, the influencing factors are determined or retained at specified times so that any development or change in the factors is recorded depending on the operating time, which has elapsed by then, for the slave flowmeters in question. In the case of a battery used as a power source, the influencing factors that have to be taken into consideration would include the switch-on frequency of the slave flowmeter in question, the slave's measuring cycle, operating time, pressure and temperature of the surroundings of the communication and power supply unit (128), (170) and a voltage drop measured in the power source per time unit or the change in the voltage drop. The voltage drop per time unit currently measured is compared against a value calculated theoretically for the configuration of the flowmeter(s). An alarm is generated when a predefined deviation threshold is exceeded. It is also possible to track a trend from several voltage drops currently measured per time unit. This trend is then compared against a value calculated theoretically for the configuration of the flowmeter(s). Here too, an alarm signal is generated when a specified deviation threshold is overshot indicating that the power source has to be replaced.

It is advisable that the process of recording the influencing factors and determining the remaining theoretical operating life of the power source be controlled and triggered by a computer integrated in the communication and power supply unit (170) (see FIG. 3), for example the data processing unit (180), in conjunction with the energy manager electronics system (178).

Practically speaking, the operating life theoretically remaining for the power source is determined each time the measuring cycle of the slave flowmeter changes, or is determined periodically if the value has not been determined in the meantime as the measuring cycles of the slave flowmeter had not changed. Here, various operating lives theoretically remaining for various value pairs of influencing factors are determined which are preferably shown on a screen to the user, together with the various value pairs of influencing factors, and the user wants to change one of the influencing factors such as the measuring cycle of the slave flowmeter. The values are displayed on a screen preferably in the measuring control room where the various theoretically remaining operating lives of the power sources of the slave flowmeters in question are transmitted to the measuring control room or central station by means of the master flowmeter. This can also be performed on a portable computer or a PC which receives the data directly from the master flowmeter or the slave flowmeters. The user should be given the option of changing the values of the value pairs or influencing factors on the computer, whereby each time the user enters or changes the value pairs of influencing factors, a new operating life theoretically remaining for the power source in question is determined, in accordance with the modified values, and shown on the display.

The influencing factors—such as the measuring cycle of the slave flowmeter in question—selected by the user for the desired operating life theoretically remaining for the power source observed should be used directly when configuring the slave flowmeter observed. This process makes sense particularly if the operating life of a power source for a slave flowmeter observed repeatedly deviates greatly from the operating lives of the power sources of other slave flowmeters. In this instance, the operating life theoretically remaining for a renewable power source of a particular flowmeter or several flowmeters is determined periodically and the operating life theoretically remaining, which is determined for the existing configuration of the slave flowmeter in question, is shown to the user. The user is then given the option of changing the configuration, particularly the measuring cycle, whereby the operating life theoretically remaining for a power source resulting from a change in the configuration is displayed. In this way, the users can decide how they can increase the operating life of the power source of the slave flowmeter in question.

We have already explained that the slave flowmeters can be measuring instruments that work on different measuring principles. For measuring the flow of water, for example, these can be ultrasonic flowmeters, electromagnetic flowmeters, Coriolis flowmeters or vortex flowmeters. Slave flowmeters with an electromagnetic measuring arrangement and an ultrasonic measuring arrangement in a common housing are particularly recommended for determining and accurately locating leaks in water pipe networks.

Pipe networks for supplying water or gas transport a salable medium to the consumers connected to the network. To be able to invoice consumers, as explained above, a central accounting center is often set up and the master flowmeter sends the flow values to be invoiced to this accounting center. In this respect it is recommended that at least one of these flowmeters in the pipe network observed is a flowmeter suitable for custody transfer measurement which preferably can be calibrated at its installation point. With regard to a pipe network for supplying gas, it is also important to know the temperature and pressure of the gas transported. Thus, preferably several slave flowmeters are fitted with a temperature sensor and a pressure sensor at specific points as illustrated in FIG. 2 and explained in the related text on the diagram.

1-40. (canceled)

41. A pipe network for supplying water or gas and/or removing industrial water, comprising:
a hierarchical structure made up of pipe branches of individual legs with several pipe branches each fitted with at least one flowmeter, wherein:
said flowmeters are standalone units;
said flowmeters are connected to a master-slave network; and
said flowmeters communicate wirelessly with one another.

42. The pipe network as per claim 41 wherein:
said pipe branch is provided with a higher-order pipe branch and a lower-order pipe branch; and
at least one flowmeter is provided in said higher-order pipe branch to act as a master flowmeter and several other flowmeters are provided in said lower-order pipe branch acting as slave flowmeters.

43. The pipe network as per claim 42, wherein:
said slave flowmeter reports a measured value it determines to said master flowmeter.

44. The pipe network as per claim 42, wherein:
said slave flowmeters report the measured values they determine in their own particular pipe branch to said master flowmeter.

45. The pipe network as per claim 44, wherein:
said slave flowmeters detect a flow direction prevalent in their particular pipe branch and report this to said master flowmeter.

46. The pipe network as per claim 45, wherein:
said master flowmeter calculates the sum of the individual measured values transmitted to it by said slave flowmeters.

47. The pipe network as per claim 46, further comprising:
a central station, wherein:
said master flowmeter communicates with said central station.

48. The pipe network as per claim 47, wherein:
said master flowmeter sends an error or alarm signal, indicating a leak, to said central station if the total of the individual measured values from said slave flowmeters deviates beyond a specific tolerance from a measured value measured by said master flowmeter itself.

49. The pipe network as per claim 41, further comprising:
a power source connected to said flowmeters, wherein:
power is supplied to said slave flowmeters at least by said power source.

50. The pipe network as per claim 49, wherein:
every slave flowmeter is assigned an individual power source.

51. The pipe network as per claim 49, wherein:
each flowmeter determines the remaining operating life of its said power source at specified times.

52. The pipe network as per claim 51, wherein:
each flowmeter determines the remaining operating life of its said power source on request.

53. The pipe network as per claim 51, wherein:
said master flowmeter communicates the remaining operating lives of said power source, determined by said slave pressure measuring instruments, to said central station.

54. The pipe network as per claim 44, characterized in that the power source is a battery.

55. The pipe network as per claim 49, in that the energy storage unit is a fuel cell.

56. The pipe network as per claim 41, wherein:
at least one of said flowmeters is a flowmeter suitable for custody transfer measurement.

57. The pipe network as per claim 41, wherein:
at least one of said flowmeters can be calibrated at its installation point.

58. The pipe network as per claim 41, wherein:
at least one of said flowmeters is an ultrasonic flowmeter.

59. The pipe network as per claim 41, wherein:
at least one of said flowmeters is an electromagnetic flowmeter.

60. The pipe network as per claim 59, wherein:
at least one of said flowmeters combines an electromagnetic measuring arrangement and a flow measuring arrangement that works with ultrasonic signals in one common housing.

61. The pipe network as per claim 41, wherein:
at least one of said flowmeters is fitted with a temperature sensor.

62. The pipe network as per claim 41, wherein:
at least one of said flowmeters is fitted with a pressure sensor.

63. The pipe network as per claim 41, wherein:
at least one sealable bypass is provided between two pipe branches.

64. The pipe network as per claim 41, wherein:
said slave flowmeters are organized on different hierarchical levels in the master-slave network, which structure is decisive for the communication of said slave flowmeters with said master flowmeter.

65. A process for detecting a leak in a pipe network for supplying water or gas and/or removing industrial water, where the pipe network includes a hierarchical structure made up of pipe branches of individual legs and several pipe branches are fitted with at least one flowmeter and where the flowmeters are standalone units, are connected to a master-slave network and communicate with one another using wireless technology, the process comprises the following steps:
reporting measured values using slave flowmeters in lower-order pipe branches, and record to the master flowmeter which is arranged in a higher-order pipe branch;
calculating a total from the measured values using the master flowmeter of the slave flowmeters of the hierarchical levels in question;
comparing this total to a value measured for the next highest hierarchical level; and
generating an alarm signal by the master flowmeter if the total of the lower-order hierarchical level deviates from the measured value measured in the next highest hierarchical level and is outside a prespecified tolerance value, which indicates that the values do not tally and requests the pipe branch or branches be inspected.

66. The process as per claim 65, further comprising the step of:
using at least two ultrasonic flowmeters to inspect a single lower-order pipe branch for a possible leak in the pipe branch affected, including lower-order pipe branches, where the time-of-flight values of the sonic signals from one ultrasonic flowmeter to another are determined and examined with regard to the sonic velocities which deviate from sonic velocities for the pipe branch, which were known or determined beforehand, taking into account a known distance between the ultrasonic flowmeters.

67. The process as per claim 65, comprising the step of:
checking the function of the slave flowmeters in the pipe branches in question using the master flowmeter before actually emitting the alarm signal, by causing the flowmeters to initialize control measurements and test sequences.

68. The process as per claim 65, further comprising the step of:
individually examining the pipe branch in question for leaks by comparing the measured values, which caused the alarm signal to be triggered, against a reference curve created for the same pipe branch from earlier measurements.

69. The process as per claim 65, further comprising the step of:
checking the function of the slave flowmeters using the master flowmeter at specified times or at specified intervals by causing the flowmeters in question to initialize function control measurements and test sequences.

70. A process for determining, with the aid of a computer, the operating life theoretically remaining for a renewable power source for at least one flowmeter in a pipe network for supplying water or gas and/or removing industrial water, comprising:
a hierarchical structure made up of pipe branches of individual legs with several pipe branches each fitted with at least one flowmeter, wherein:
said flowmeters are standalone units;
said flowmeters are connected to a master-slave network; and
said flowmeters communicate wirelessly with one another, comprising the following steps:
determining a matrix of influencing factors which affect the theoretical operating life of the power source;
determining a theoretical operating life with a variation of different influencing factors or a combination thereof;
recording all the influencing factors from the point when the power source is installed to when it fails or terminates;
recording at least the influencing factors at specified times as a function of an operating time, which has elapsed by then, of the flowmeter in question;
determining the operating life theoretically remaining with the aid of a matrix taking into account all the influencing factors recorded to date and the operating time that has elapsed; and
performing all the process steps previously mentioned on a computer connected to the flowmeter or flowmeters.

71. The process as per claim 70, further comprising the step of:
determining the operating life of the power source theoretically remaining each time the measuring cycles of the flowmeter are changed.

72. The process as per claim 70, wherein:
the operating life theoretically remaining for the power source is determined periodically if the value has not been determined in the meantime as the measuring cycles had not changed.

73. The process as per claim 70, which is used to determine the operating life theoretically remaining, comprising the further steps of:
determining, using the various operating lives theoretically remaining for various value pairs of influencing factors;
displaying the various operating lives theoretically remaining to the user on a display unit together with the various influencing factor value pairs, whereby the user is allowed change the values of the value pairs or the influencing factors on a data input unit of the computer; and
calculating, using the computer, a new operating life theoretically remaining based on the modified values and displays this on the computer display unit, when the user enters or changes the value pairs of influencing factors.

74. The process as per claim 73, wherein:
for a value pair of influencing factors that the user ultimately selects, the computer uses the influencing factors which affect a required measuring cycle of the flowmeter or flowmeters to configure the flowmeter(s).

75. The process as per claim 74, wherein:
the operating life theoretically remaining for a renewable power source of one particular flowmeter or several flowmeters is determined periodically, such that the operating life theoretically remaining for the flowmeter(s) with the existing configuration is shown to the user who then has the option of changing the configuration and the new operating life theoretically remaining, as a result of the modified configuration, is then indicated.

76. The process as per claim 70, wherein:
in that in the case of a battery or a unit consisting of several batteries that act as the power source for the flowmeter(s), a voltage drop measured in the power source per time is taken into account as an influencing factor when determining the current operating time theoretically remaining for the power source.

77. The process as per claim 76, further comprising the step of:
comparing the current measured voltage drop per time unit to a theoretical value calculated for the particular configuration of the flowmeter(s) and in that an alarm is generated if a specified deviation threshold is exceeded.

78. The process as per claim 76, wherein:
a trend is determined from several voltage drops currently measured per time unit and in that this trend is compared to a theoretical value calculated for the particular configuration of the flowmeter(s) and in that an alarm is generated if a specified deviation threshold is exceeded.

79. The process as per claim 77, further comprising the step of:
generating a signal when a predefined operating life theoretically remaining is undershot and in that this signal indicates that the power source has to be replaced.
